(19) United States
(12) Patent Application Publication
(10) Pub. No.: US 2024/0420566 A1
(43) Pub. Date: Dec. 19, 2024

(54) RESOURCE ALLOCATION USING VEHICLE MANEUVER PREDICTION

(71) Applicant: Telefonaktiebolaget LM Ericsson (publ), Stockholm (SE)

(72) Inventors: Khaled KORD, Mississauga (CA); Ahmed ELBERY, Kingston (CA); Sameh SOROUR, Kingston (CA); Akram BIN SEDIQ, Kanata (CA); Ali AFANA, Kanata (CA); Hatem ABOU-ZEID, Calgary (CA)

(21) Appl. No.: 18/700,107

(22) PCT Filed: Oct. 7, 2022
(86) PCT No.: PCT/IB2022/059639

§ 371 Date: Apr. 10, 2024

Related U.S. Application Data
(60) Provisional application No. 63/254,316, filed on Oct. 11, 2021.

(51) Int. Cl. G08G 1/01; H04W 72/51

(52) U.S. Cl. CPC G08G 1/0125; G08G 1/0112; H04W 72/51

(57) ABSTRACT

A method, system and apparatus are disclosed. A network node configured to communicate with a wireless device (WD) is described. The WD corresponds to a vehicle, and the network node comprises processing circuitry configured to predict a vehicle maneuver, where the prediction is based at least in part on a learning process associated with vehicle data; and schedule a resource usable at least by the WD. The scheduling is based on the predicted vehicle maneuver.

### TECHNICAL FIELD

The present disclosure relates to wireless communications, and in particular, to resource allocation using vehicle maneuver prediction.

### BACKGROUND

An autonomous vehicle (AV) deployed in complex traffic should balance two factors: efficient mobility without stalling traffic, and the safety of humans and properties around it. The vehicle should have the ability to take initiative such as deciding when to change lanes, cross intersections, or overtake another vehicle. More importantly, the vehicle should coordinate its motion with surrounding vehicles. Traditionally, vehicle-to-everything (V2X) communication had been utilized for information exchange required in cooperative driving. Two main technologies have been popularized to allow V2X, cellular based C-V2X and dedicated short-range communication (DRSC). DRSC technology is based on Institute of Electrical and Electronics Engineers (IEEE) 802.11p standard which faces many challenges such as limited mobility support and limited bandwidth leading to shortcomings in terms of reliability and latency. On the other hand, C-V2X is gaining a foothold with the 3^{rd} Generation Partnership Project (3GPP) 5^{th} Generation (5G, also called New Radio or NR). This new generation of cellular networks comes with promising capabilities that may allow for C-V2X based cooperative driving. Although promising, the 5G standard for C-V2X is a work in progress that still requires further enhancements to fully and safely support advanced AV applications scenarios such as cooperative lane change and trajectory alignment for platooning. These advanced scenarios call for innovative techniques to enhance the efficiency of how resources are allocated in next 5G releases. Further enhancements should aim at reducing as much overhead as possible while satisfying the latency and reliability requirements for cooperative driving tasks.

Improving network resource allocation in cellular based V2X communications has been studied (e.g., where some studies include surveys about sharing resource blocks (RBs) based on user clustering). Hybrid schemes in which DRSC is used to assist C-V2X, and Artificial Intelligence (AI) enabled predictive resource allocation based on mobility patterns have been proposed. However, such proposals fail to enhance resource allocation such as uplink (UL) resource allocation. Moreover, mobility patterns are not typically classified into their corresponding maneuvers. Further, cooperative driving demands different service requirements based on maneuver scenario and the service provider level of support to driving automation.

In the next subsection, a UL scheduling process, e.g., in 3GPP Long Term Evolution (LTE) and 5G, is described.

### UL Scheduling in LTE and 5G:

In order to achieve collision-free UL scheduling, where any two wireless devices (WDs) in the same cell do not transmit on the same radio resource, both LTE and 5G traditionally rely on the network node (e.g., base station) to coordinate the UL scheduling. This could be done by conveying the UL scheduling decision to the WDs in either dynamic manner, or semi-static manner. In the former, the network node dynamically conveys the uplink resource assignment to a WD (e.g., user) every transmission time interval by sending an UL grant in the physical downlink control channel (PDCCH) to the WD. The grant typically contains information about the radio resources that the WD is expected to use for transmitting its uplink data. In semi-static methods, the network node allocates periodic resources to a WD in advance, e.g., a WD may be requested to transmit in a given radio resources every X milliseconds (msec). The network node can also deallocate the periodic resources allocated to the WD also in a semi-static manner. In LTE, semi-static methods are used in semi-persistent scheduling, while in 5G NR, configured grants are introduced to achieve the same objective.

To make UL resource allocation, the network node may need to know whether the WD has data to transmit and/or how much data the WD has in its buffer (to be transmitted). For the network node to acquire such knowledge, it may assign a periodic scheduling request (SR) resource to the WD when the WD connects to the network node. SR messages are typically 1-bit of size used only to signal the WD need for resources. A typical period for the SR resource in LTE and NR is 10 msec but other values are also allowed in the 3GPP standard.

After the network node successfully decodes the SR, the network node schedules the WD with an uplink grant. Using SR alone, the network node cannot know exactly the amount of the data that the WD has in the buffer. Thus, typically the network node sends a small UL grant which the WD can use to send a buffer-status-report (BSR) that indicates the range of the amount of data that the WD has in its buffer which can be used by the network node for UL scheduling. This approach has the advantage that there is no UL wasted grants as the network node does not send UL grant to a WD unless it knows that the WD has data to transmit; however, it has the disadvantage of increased latency as the network node may wait for SR and BSR before it schedules the UL grant that satisfies the WD requirements.

Choosing between dynamic resource allocation and semi-static resource allocation is a tradeoff between latency and resource consumption. In dynamic methods, the WD waits for the SR opportunity to inform the network node of UL data arrival. Furthermore, the WD waits for the network node reply to its buffer-status report. This translates into an added latency that is not acceptable by delay-critical applications. One the other hand, the added latency overhead could be avoided by using semi-persistent scheduling and configured grants; however, this approach can result in a considerable amount in wasted resources.

UL prescheduling may be used, e.g., where a PDCCH UL grant is scheduled from the network node in advance whether periodically or whenever a condition is met. While this reduces latency, it also suffers from waste of resources when the WD does not have UL data to transmit in its pre-allocated resources in advance. One way to reduce the waste of resources may be to configure a static parameter, i.e., prescheduling duration. This parameter is used to stop prescheduling if there are no UL transmission carrying useful data (i.e., not just UL padding) during this time. This parameter controls the aggressiveness of prescheduling such that decreasing this parameter results in less wasted grants but worse latency (and vice versa).

In sum, existing technologies suffer from high latency or waste of resources. Further, existing technologies cannot adequately allocate resources demanded by applications such as autonomous vehicle (AV) and cooperative driving, where efficient mobility and safety are critical.

### SUMMARY

Some embodiments provide a way to at least reduce wasted resources (e.g., of existing technologies). In some embodiments, one or more predictions are performed. Machine learning may be used to predict the probability that a WD has UL data to transmit and use that probability in determining whether to schedule UL grants. Some other embodiments advantageously provide methods, systems, and apparatuses for resource allocation (e.g., enhanced C-V2X uplink resource allocation) using vehicle maneuver prediction.

In one embodiment, a network node is configured to predict a maneuver of the WD, where the prediction is based on learning (e.g., a learning prosses) from vehicle state data. WD (and/or resources associated with the WD) may be scheduled based on the predicted maneuver.

In another embodiment, a WD is configured to receive, by a vehicle application layer, data associated with vehicle-to-everything (V2X); and as a result of the data, send a physical uplink (UL) channel message on a resource scheduled by the network node based on a predicted maneuver.

In some embodiments, network resources used by a vehicle (i.e., wireless devices associated with vehicles) may be correlated with the type of maneuver it intends to perform.

According to an aspect, a network node configured to communicate with a wireless device (WD) is described. The WD corresponds to a vehicle, and the network node comprises processing circuitry configured to predict a vehicle maneuver, where the prediction is based at least in part on a learning process associated with vehicle data; and schedule a resource usable at least by the WD. The scheduling is based on the predicted vehicle maneuver.

In some embodiments, the network node further comprises a radio interface in communication with the processing circuitry. The radio interface is configured to at least one of receive the vehicle data from the WD; transmit first signaling to the WD including the scheduled resource; receive second signaling from the WD based on the scheduled resource; and transmit third signaling to another WD based on the scheduled resource. The third signaling is usable by the other WD to determine that the vehicle maneuver has been predicted.

In some other embodiments, the scheduled resource is usable at least by the WD to at least one of: perform at least one action associated with vehicle to everything (V2X) communication; and trigger a cooperative driving action.

In an embodiment, the processing circuitry is further configured to determine a probability of the vehicle maneuver to predict the vehicle maneuver.

In another embodiment, the processing circuitry is further configured to one of activate and deactivate a semi-static scheduling of the resource based on the determined probability and a probability threshold.

In some embodiments, the probability is determined based at least on an input associated with the learning process.

In some other embodiments, the resource is scheduled to be transmitted in advance of the vehicle maneuver occurring by at least a predetermined interval of time.

In an embodiment, the processing circuitry is further configured to perform the learning process based at least in part on the vehicle data.

In another embodiment, at least one of the WD is a vehicular WD; the scheduled resource is at least one of an uplink grant and a downlink grant; and the predicted vehicle maneuver comprises at least one of changing lanes; passing another vehicle; crossing an intersection; coordinating a physical maneuver with at least one neighboring vehicle; and a maneuver expected to be performed by the vehicle within a predetermined interval of time.

In some embodiments, the vehicle data comprises at least one of historical data; vehicle coordinate and speed data; an interval of time associated with the historical data; a quantity of surrounding vehicles; and data about the surrounding vehicles at a predetermined time.

According to another aspect, a method in a network node configured to communicate with a wireless device (WD) is described. The WD corresponds to a vehicle, and the method comprises predicting a vehicle maneuver, the prediction being based at least in part on a learning process associated with vehicle data; and scheduling a resource usable at least by the WD, the scheduling being based on the predicted vehicle maneuver.

In some embodiments, the method further includes at least one of receiving the vehicle data from the WD; transmitting first signaling to the WD including the scheduled resource; receiving second signaling from the WD based on the scheduled resource; and transmitting third signaling to another WD based on the scheduled resource. The third signaling is usable by the other WD to determine that the vehicle maneuver has been predicted.

In some other embodiments, the scheduled resource is usable at least by the WD to at least one of perform at least one action associated with vehicle to everything (V2X) communication; and trigger a cooperative driving action.

In an embodiment, the method further includes determining a probability of the vehicle maneuver to predict the vehicle maneuver.

In another embodiment, the method further includes one of activating and deactivating a semi-static scheduling of the resource based on the determined probability and a probability threshold.

In some embodiments, the probability is determined based at least on an input associated with the learning process.

In some other embodiments, the resource is scheduled to be transmitted in advance of the vehicle maneuver occurring by at least a predetermined interval of time.

In an embodiment, the method further includes performing the learning process based at least in part on the vehicle data.

In another embodiment, at least one of the WD is a vehicular WD; the scheduled resource is at least one of an uplink grant and a downlink grant; and the predicted vehicle maneuver comprises at least one of changing lanes; passing another vehicle; crossing an intersection; coordinating a physical maneuver with at least one neighboring vehicle; and a maneuver expected to be performed by the vehicle within a predetermined interval of time.

In some embodiments, the vehicle data comprises at least one of historical data; vehicle coordinate and speed data; an interval of time associated with the historical data; a quantity of surrounding vehicles; and data about the surrounding vehicles at a predetermined time.

According to an aspect, a wireless device (WD) configured to communicate with a network node is described. The WD corresponds to a vehicle and comprises a radio interface and processing circuitry in communication with the radio interface. The radio interface is configured to receive a resource usable by the WD. The resource is scheduled by the network node based on a predicted vehicle maneuver, and the predicted vehicle maneuver is based at least in part on a learning process associated with vehicle data. The processing circuitry is configured to at least one of perform at least one action associated with vehicle to everything (V2X) communication; and trigger a cooperative driving action.

In some embodiments, the radio interface is further configured to at least one of transmit the vehicle data to the network node; receive first signaling from the network node including the received resource; transmit second signaling to the network node based on the received resource; and transmit third signaling to another WD based on the received resource. The third signaling is usable by the other WD to determine that the vehicle maneuver has been predicted.

In some other embodiments, the predicted vehicle maneuver is based on a probability.

In an embodiment, a semi-static scheduling of the resource is one of activated and deactivated based on the probability and a probability threshold.

In another embodiment, the probability is based at least on an input associated with the learning process.

In some embodiments, the resource is scheduled to be transmitted in advance of the vehicle maneuver occurring by at least a predetermined interval of time.

In some other embodiments, the learning process is based at least in part on the vehicle data.

In an embodiment, at least one of the WD is a vehicular WD; and the received resource is at least one of an uplink grant and a downlink grant.

In another embodiment, the predicted vehicle maneuver comprises at least one of changing lanes; passing another vehicle; crossing an intersection; coordinating a physical maneuver with at least one neighboring vehicle; and a maneuver expected to be performed by the vehicle within a predetermined interval of time.

In some embodiments, the vehicle data comprises at least one of historical data; vehicle coordinate and speed data; an interval of time associated with the historical data; a quantity of surrounding vehicles; and data about the surrounding vehicles at a predetermined time.

According to another aspect, a method in a wireless device (WD) configured to communicate with a network node. The WD corresponds to a vehicle, and the method comprises receiving a resource usable by the WD, where the resource is scheduled by the network node based on a predicted vehicle maneuver, and the predicted vehicle maneuver is based at least in part on a learning process associated with vehicle data; and at least one of performing at least one action associated with vehicle to everything (V2X) communication; and triggering a cooperative driving action.

In some embodiments, the method further includes at least one of transmitting the vehicle data to the network node; receiving first signaling from the network node including the received resource; transmitting second signaling to the network node based on the received resource; and transmitting third signaling to another WD based on the received resource. The third signaling is usable by the other WD to determine that the vehicle maneuver has been predicted.

In an embodiment, the predicted vehicle maneuver is based on a probability.

In another embodiment, a semi-static scheduling of the resource is one of activated and deactivated based on the probability and a probability threshold.

In some embodiments, the probability is based at least on an input associated with the learning process.

In some other embodiments, the resource is scheduled to be transmitted in advance of the vehicle maneuver occurring by at least a predetermined interval of time.

In an embodiment, the learning process is based at least in part on the vehicle data.

In another embodiment, at least one of the WD is a vehicular WD; and the received resource is at least one of an uplink grant and a downlink grant.

In some embodiments, the predicted vehicle maneuver comprises at least one of changing lanes; passing another vehicle; crossing an intersection; coordinating a physical maneuver with at least one neighboring vehicle; and a maneuver expected to be performed by the vehicle within a predetermined interval of time.

In some other embodiments, the vehicle data comprises at least one of historical data; vehicle coordinate and speed data; an interval of time associated with the historical data; a quantity of surrounding vehicles; and data about the surrounding vehicles at a predetermined time.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a schematic diagram of an example network architecture illustrating a communication system connected via an intermediate network to a host computer according to the principles in the present disclosure;

FIG. 2 is a block diagram of a host computer communicating via a network node with a wireless device over an at least partially wireless connection according to some embodiments of the present disclosure;

FIG. 3 is a flowchart illustrating example methods implemented in a communication system including a host computer, a network node and a wireless device for executing a client application at a wireless device according to some embodiments of the present disclosure;

FIG. 4 is a flowchart illustrating example methods implemented in a communication system including a host computer, a network node and a wireless device for receiving user data at a wireless device according to some embodiments of the present disclosure;

FIG. 5 is a flowchart illustrating example methods implemented in a communication system including a host computer, a network node and a wireless device for receiving user data from the wireless device at a host computer according to some embodiments of the present disclosure;

FIG. 6 is a flowchart illustrating example methods implemented in a communication system including a host computer, a network node and a wireless device for receiving user data at a host computer according to some embodiments of the present disclosure;

FIG. 7 is a flowchart of an example process in a network node according to some embodiments of the present disclosure;

FIG. 8 is a flowchart of an example process in a wireless device according to some embodiments of the present disclosure;

FIG. 9 is a flowchart of another example process in a network node according to some embodiments of the present disclosure;

FIG. 10 is a flowchart of another example process in a wireless device according to some embodiments of the present disclosure;

FIG. 11 illustrates an example scheme for assigning dynamic resources (e.g., grants) in UL scheduling according to some embodiments of the present disclosure;

FIG. 12 illustrates an example proposed scheme for scheduling one or more resources (e.g., uplink grants in C-V2X) according to some embodiments of the present disclosure;

FIG. 13 illustrates an example LSTM prediction model according to some embodiments of the present disclosure;

FIG. 14 illustrates an example cross entropy loss for LSTM model under different prediction horizons according to some embodiments of the present disclosure;

FIG. 15 illustrates an example of Latency under varying background traffic according to some embodiments of the present disclosure;

FIG. 16 illustrates an example of Reliability under varying background traffic according to some embodiments of the present disclosure;

FIG. 17 illustrates an example of Reliability with different number of connected vehicles according to some embodiments of the present disclosure;

FIG. 18 illustrates an example of Average delay and the corresponding wasted resources according to some embodiments of the present disclosure;

FIG. 19 illustrates an example of the Proposed scheme for UL scheduling according to some embodiments of the present disclosure according to some embodiments of the present disclosure; and

FIG. 20 illustrates another example of the Proposed scheme for UL scheduling according to some embodiments of the present disclosure.

### DETAILED DESCRIPTION

The 5G standard for C-V2X defines strict requirements to safely support autonomous vehicles applications. As an example, the maximum end-to-end latency required to support the exchange of cooperative lane change information between WDs is 10 millisecond (ms) with minimum reliability over 99%. Traditional schemes for uplink resource allocation suffer from either high latency or waste of resources. Dynamic resource allocation relies on a round trip of control message exchange to establish the physical control channels (physical uplink control channel-downlink control channel/PUCCH-PDCCH). The latency resulting from this process alone can easily exceed the maximum acceptable delay to support cooperative driving in autonomous vehicles. This could be avoided using semi-persistent in LTE or configured grants in 5G; however, these approaches lead to a considerable waste of resources. Existing solutions do not utilize vehicle maneuver prediction which, as discussed in more detail below, can further reduce latency and wasted resources.

Traditional solutions to grant UL resources for WDs require requesting these resources then waiting for radio access networks (RANs) to grant it. Instead, some embodiments of the present disclosure provide arrangements for predicting vehicle maneuver (and/or vehicle maneuver intention) on the network node (e.g., gNB) side; hence, the network node may be able to proactively grant resources to signal such intention to surrounding vehicle which may result in a decrease in end-to-end delay in C-V2X packet exchange.

Some embodiments provide arrangements for relying on prediction methods, installed on the network node (e.g., gNB) side of the network, to predict the future need for UL resources to support vehicle maneuvering. The prediction may also be used to proactively grant the resources to the WD (e.g., onboard WD in these vehicles).

Some embodiments advantageously provide solutions to decrease end-to-end delay in the 5G UL resource granting scheme by avoiding the latency resulting from the traditional resource scheduling protocol and avoiding wasting excessive amounts of UL resources. This may open the door for 5G NR to support critical use cases such as, but not limited to, cooperative driving for autonomous vehicles, even under relatively harsh network conditions.

Before describing in detail example embodiments, it is noted that the embodiments reside primarily in combinations of apparatus components and processing steps related to resource allocation/scheduling (e.g., enhanced C-V2X uplink resource allocation/scheduling) using vehicle maneuver prediction. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device, etc. The WD (and “onboard WD”) may be a vehicle and or a device incorporated within a vehicle, whether permanently integrated with the remainder of the vehicle or removable as in the case of a wireless handset, laptop, mobile terminal, etc. In other words, the terms “WD” and “onboard WD” are used interchangeably throughout this disclosure. The term vehicular WD may refer to a WD comprised in (and/or part of and/or integrated with and/or in communication with) a vehicle/vehicle components.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

The term “signaling” used herein may comprise any of: high-layer signaling (e.g., via Radio Resource Control (RRC) or a like), lower-layer signaling (e.g., via a physical control channel or a broadcast channel), or a combination thereof. The signaling may be implicit or explicit. The signaling may further be unicast, multicast or broadcast. The signaling may also be directly to another node or via a third node.

Generally, it may be considered that the network, e.g. a signaling radio node and/or node arrangement (e.g., network node), configures a WD, in particular with the transmission resources. A resource may in general be configured with one or more messages. Different resources may be configured with different messages, and/or with messages on different layers or layer combinations. The size of a resource may be represented in symbols and/or subcarriers and/or resource elements and/or physical resource blocks (depending on domain), and/or in number of bits it may carry, e.g. information or payload bits, or total number of bits. The set of resources, and/or the resources of the sets, may pertain to the same carrier and/or bandwidth part, and/or may be located in the same slot, or in neighboring slots.

In some embodiments, control information on one or more resources may be considered to be transmitted in a message having a specific format. A message may comprise or represent bits representing payload information and coding bits, e.g., for error coding.

Receiving (or obtaining) control information may comprise receiving one or more control information messages. It may be considered that receiving control signaling comprises demodulating and/or decoding and/or detecting, e.g. blind detection of, one or more messages, in particular a message carried by the control signaling, e.g. based on an assumed set of resources, which may be searched and/or listened for the control information. It may be assumed that both sides of the communication are aware of the configurations, and may determine the set of resources, e.g. based on the reference size.

Signaling may generally comprise one or more symbols and/or signals and/or messages. A signal may comprise or represent one or more bits. An indication may represent signaling, and/or be implemented as a signal, or as a plurality of signals. One or more signals may be included in and/or represented by a message. Signaling, in particular control signaling, may comprise a plurality of signals and/or messages, which may be transmitted on different carriers and/or be associated to different signaling processes, e.g. representing and/or pertaining to one or more such processes and/or corresponding information. An indication may comprise signaling, and/or a plurality of signals and/or messages and/or may be comprised therein, which may be transmitted on different carriers and/or be associated to different acknowledgement signaling processes, e.g. representing and/or pertaining to one or more such processes. Signaling associated to a channel may be transmitted such that represents signaling and/or information for that channel, and/or that the signaling is interpreted by the transmitter and/or receiver to belong to that channel. Such signaling may generally comply with transmission parameters and/or format/s for the channel.

An indication generally may explicitly and/or implicitly indicate the information it represents and/or indicates. Implicit indication may for example be based on position and/or resource used for transmission. Explicit indication may for example be based on a parametrization with one or more parameters, and/or one or more index or indices corresponding to a table, and/or one or more bit patterns representing the information.

A channel may generally be a logical, transport or physical channel. A channel may comprise and/or be arranged on one or more carriers, in particular a plurality of subcarriers. A channel carrying and/or for carrying control signaling/control information may be considered a control channel, in particular if it is a physical layer channel and/or if it carries control plane information. Analogously, a channel carrying and/or for carrying data signaling/user information may be considered a data channel, in particular if it is a physical layer channel and/or if it carries user plane information. A channel may be defined for a specific communication direction, or for two complementary communication directions (e.g., UL and DL, or sidelink in two directions), in which case it may be considered to have at least two component channels, one for each direction. Examples of channels comprise a channel for low latency and/or high reliability transmission, in particular a channel for Ultra-Reliable Low Latency Communication (URLLC), which may be for control and/or data.

Transmitting in downlink may pertain to transmission from the network or network node to the terminal. The terminal may be considered the WD or UE. Transmitting in uplink may pertain to transmission from the terminal to the network or network node. Transmitting in sidelink may pertain to (direct) transmission from one terminal to another. Uplink, downlink and sidelink (e.g., sidelink transmission and reception) may be considered communication directions. In some variants, uplink and downlink may also be used to described wireless communication between network nodes, e.g., for wireless backhaul and/or relay communication and/or (wireless) network communication for example between base stations or similar network nodes, in particular communication terminating at such. It may be considered that backhaul and/or relay communication and/or network communication is implemented as a form of sidelink or uplink communication or similar thereto.

### Configuring a Radio Node

Configuring a radio node, in particular a terminal or user equipment or the WD, may refer to the radio node being adapted or caused or set and/or instructed to operate according to the configuration. Configuring may be done by another device, e.g., a network node (for example, a radio node of the network like a base station or gNodeB) or network, in which case it may comprise transmitting configuration data to the radio node to be configured. Such configuration data may represent the configuration to be configured and/or comprise one or more instruction pertaining to a configuration, e.g. a configuration for transmitting and/or receiving on allocated resources, in particular frequency resources, or e.g., configuration for performing certain measurements on certain subframes or radio resources. A radio node may configure itself, e.g., based on configuration data received from a network or network node. A network node may use, and/or be adapted to use, its circuitry/ies for configuring. Allocation information may be considered a form of configuration data. Configuration data may comprise and/or be represented by configuration information, and/or one or more corresponding indications and/or message/s.

### Configuring in General

Generally, configuring may include determining configuration data representing the configuration and providing, e.g. transmitting, it to one or more other nodes (parallel and/or sequentially), which may transmit it further to the radio node (or another node, which may be repeated until it reaches the wireless device). Alternatively, or additionally, configuring a radio node, e.g., by a network node or other device, may include receiving configuration data and/or data pertaining to configuration data, e.g., from another node like a network node, which may be a higher-level node of the network, and/or transmitting received configuration data to the radio node. Accordingly, determining a configuration and transmitting the configuration data to the radio node may be performed by different network nodes or entities, which may be able to communicate via a suitable interface, e.g., an X2 interface in the case of LTE or a corresponding interface for NR. Configuring a terminal (e.g. WD) may comprise scheduling downlink and/or uplink transmissions for the terminal, e.g. downlink data and/or downlink control signaling and/or DCI and/or uplink control or data or communication signaling, in particular acknowledgement signaling, and/or configuring resources and/or a resource pool therefor. In particular, configuring a terminal (e.g. WD) may comprise configuring the WD to perform certain measurements on certain subframes or radio resources and reporting such measurements according to embodiments of the present disclosure.

The term time resource used herein may correspond to any type of physical resource or radio resource expressed in terms of length of time. Examples of time resources are: symbol, time slot, sub-slot, subframe, radio frame, TTI, interleaving time, etc. As used herein, in some embodiments, the terms “subframe,” “slot,” “sub-slot”, “sub-frame/slot” and “time resource” are used interchangeably and are intended to indicate a time resource and/or a time resource number.

A cell may be generally a communication cell, e.g., of a cellular or mobile communication network, provided by a node. A serving cell may be a cell on or via which a network node (the node providing or associated to the cell, e.g., base station or gNodeB) transmits and/or may transmit data (which may be data other than broadcast data) to a user equipment, in particular control and/or user or payload data, and/or via or on which a user equipment transmits and/or may transmit data to the node; a serving cell may be a cell for or on which the user equipment is configured and/or to which it is synchronized and/or has performed an access procedure, e.g., a random access procedure, and/or in relation to which it is in a RRC_connected or RRC_idle state, e.g., in case the node and/or user equipment and/or network follow the LTE and/or NR-standard. One or more carriers (e.g., uplink and/or downlink carrier/s and/or a carrier for both uplink and downlink) may be associated to a cell.

It may be considered for cellular communication there is provided at least one uplink (UL) connection and/or channel and/or carrier and at least one downlink (DL) connection and/or channel and/or carrier, e.g., via and/or defining a cell, which may be provided by a network node, in particular a base station or gNodeB. An uplink direction may refer to a data transfer direction from a terminal to a network node, e.g., base station and/or relay station. A downlink direction may refer to a data transfer direction from a network node, e.g., base station and/or relay node, to a terminal. UL and DL may be associated to different frequency resources, e.g., carriers and/or spectral bands. A cell may comprise at least one uplink carrier and at least one downlink carrier, which may have different frequency bands. A network node, e.g., a base station or eNodeB, may be adapted to provide and/or define and/or control one or more cells, e.g., a PCell and/or a LA cell.

In some embodiments, the term “vehicle data” may refer to any data and/or information. The data and/or information may be associated with a vehicle and/or a device such as a WD and/or network node. The vehicle data may be usable by one or more WDs and/or network nodes to perform one or more predictions, which may include vehicle maneuver predictions. Vehicle data may include data and/or information associated with a status of the vehicle (and/or vehicle components such as sensors). In one nonlimiting example, vehicle data may include any event, position/location/altitude/elevation of the vehicle, vehicle state data, engine/motor parameters, safety systems parameters, video/audio, user inputs, configuration parameters, tuning parameters, system/device/component status, sensor parameters, actuator parameters, motion parameters, and/or any other type of data. In another nonlimiting example, vehicle data may include historical data, vehicle coordinate and speed data, an interval of time associated with the historical data, a quantity of surrounding vehicles, and/or data about the surrounding vehicles at a predetermined time.

In one or more embodiments, the term “vehicle maneuver” may refer to any maneuver. The maneuver may correspond to one or more vehicles and/or WDs. The maneuver may be associated with vehicle driving such as autonomous vehicle driving and/or cooperative driving. The maneuver may include any maneuver that is performed during driving, parking, and/or operating the vehicle in any manner. In a nonlimiting example, a vehicle maneuver may include any of the following: changing lanes, passing another vehicle, crossing an intersection, coordinating a physical maneuver with at least one neighboring vehicle, a maneuver expected to be performed by the vehicle within a predetermined interval of time and/or any other type of maneuver.

In some embodiments, the term “resource” may refer to one or more resources such as uplink resource, downlink resources, sidelink resources, and/or any other resources usable for communication such as wireless/wired communications. Example resources may include resources associated with (and/or including) UL grants, DL grants, and/or any control/data signaling.

In some other embodiments, the term “learning process” may refer to any learning process (and/or associated steps/actions) such as machine learning (e.g., supervised, semi-supervised, unsupervised, and reinforcement learning), machine learning models, artificial intelligence, any prediction model such as long term LTSM models, random forest, supported vector machines, multilayer perceptron, neural network such as recurrent neural networks, and/or any other learning process.

In one or more embodiments, cooperative driving may include driving (e.g., of vehicles) where one or more actions are performed to cooperate with the automation of driving such as the driving of autonomous vehicles and/or other vehicles. Cooperative driving may include one or more vehicle maneuvers, e.g., performed in response to a maneuver (e.g., an expected/predicted maneuver) of another vehicle and/or to cooperate with the automation of driving and/or with driving in general. Further, cooperative driving may refer to driving where communication and cooperation is enabled between equipped vehicles, infrastructure, and other vehicles and/or persons. Cooperation may include status sharing, intent sharing, agreement seeking actions, etc. Cooperative driving may influence one or more neighboring vehicles such as vehicles with AV feature(s). Cooperative driving actions may include any actions associated with cooperative driving.

Predefined in the context of this disclosure may refer to the related information being defined for example in a standard, and/or being available without specific configuration from a network or network node, e.g. stored in memory, for example independent of being configured. Configured or configurable may be considered to pertain to the corresponding information being set/configured, e.g. by the network or a network node.

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

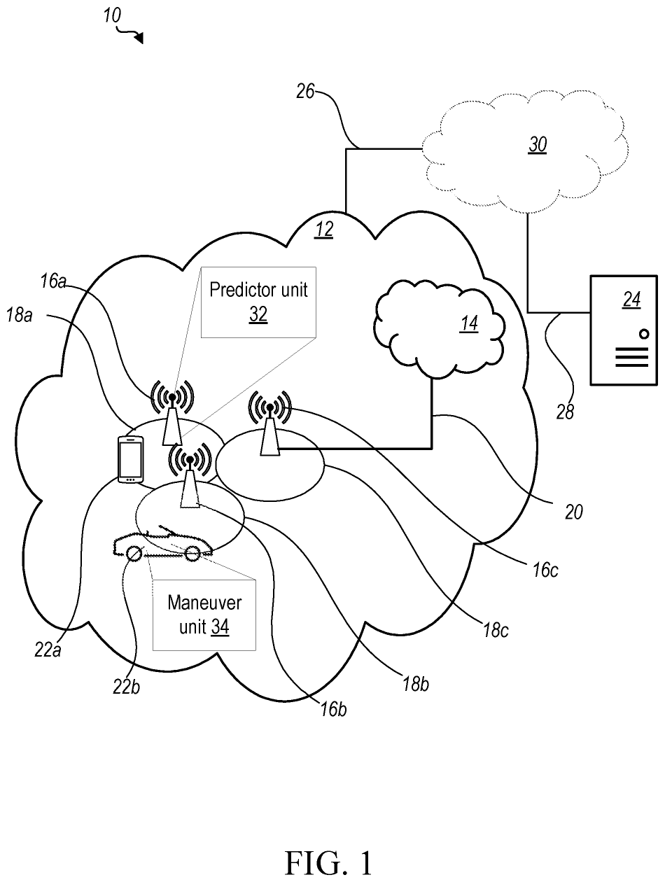

Some embodiments provide arrangements for enhanced C-V2X uplink resource allocation using vehicle maneuver prediction. Referring now to the drawing figures, in which like elements are referred to by like reference numerals, there is shown in FIG. 1 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b, such as a vehicle WD 22 or comprised in a vehicle, in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 1 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not be informed about the past routing of an incoming downlink communication with data originating from a host computer 24 to be forwarded (e.g., handed over) to a connected WD 22a. Similarly, the network node 16 may not be aware of the future routing of an outgoing uplink communication originating from the WD 22a towards the host computer 24.

A network node 16 is configured to include a predictor unit 32 which is configured to perform any step and/or task and/or process and/or method and/or feature described in the present disclosure, e.g., predict a maneuver of the WD such as where the prediction is based on learning from vehicle state data, and/or and schedule the WD (and/or a resourced) based on the predicted maneuver.

A wireless device 22 is configured to include a maneuver unit 34 which is configured to perform any step and/or task and/or process and/or method and/or feature described in the present disclosure, e.g., receive a resource usable by the WD, the resource being scheduled by the network node based on a predicted vehicle maneuver, the predicted vehicle maneuver being based at least in part on a learning process associated with vehicle data; perform at least one action associated with vehicle to everything, V2X, communication; and/or trigger a cooperative driving action.

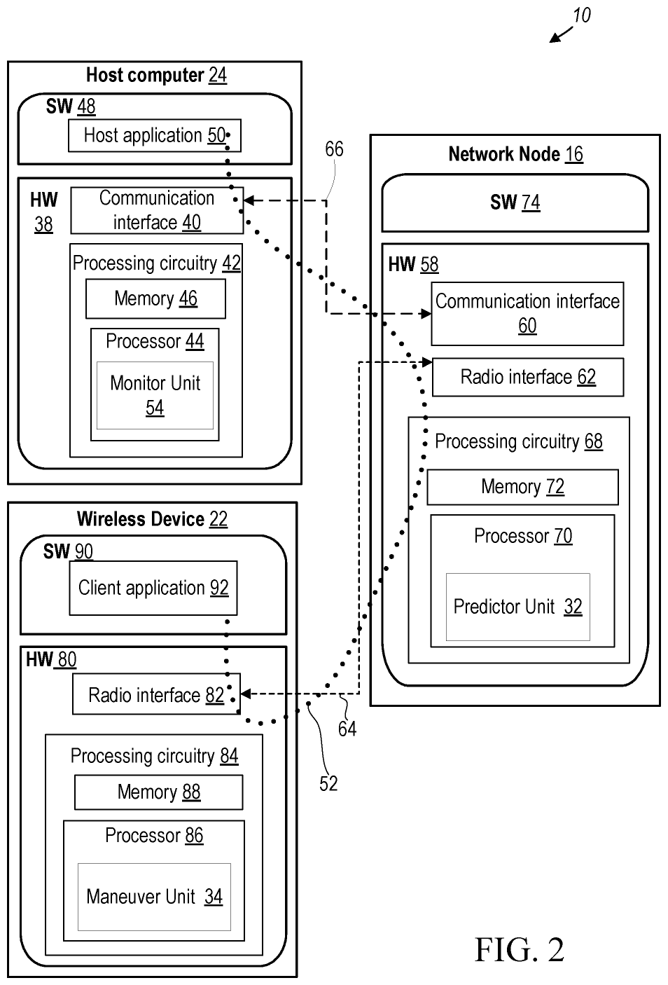

Example implementations, in accordance with an embodiment, of the WD 22, network node 16 and host computer 24 discussed in the preceding paragraphs will now be described with reference to FIG. 2. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and/or the wireless device 22. The processing circuitry 42 of the host computer 24 may include a monitor unit 54 configured to perform any step and/or task and/or process and/or method and/or feature described in the present disclosure, e.g., enable the service provider to observe, monitor, control, transmit to and/or receive from the network node 16 and/or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. Software 74 may include any software application such as a vehicle application. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include predictor unit 32 configured to perform network node methods discussed herein.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include a maneuver unit 34 configured to perform WD methods discussed herein.

In some embodiments, the inner workings of the network node 16, WD 22, and host computer 24 may be as shown in FIG. 2 and independently, the surrounding network topology may be that of FIG. 1.

In FIG. 2, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring may not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 1 and 2 show various “units” such as predictor unit 32, and maneuver unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

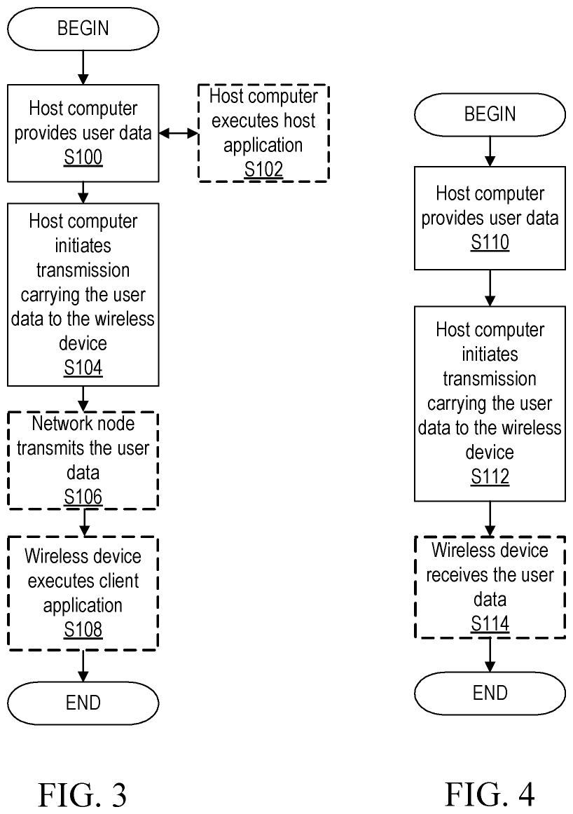

FIG. 3 is a flowchart illustrating an example method implemented in a communication system, such as, for example, the communication system of FIGS. 1 and 2, in accordance with one embodiment. The communication system may include a host computer 24, a network node 16 and a WD 22, which may be those described with reference to FIG. 2. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 4 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

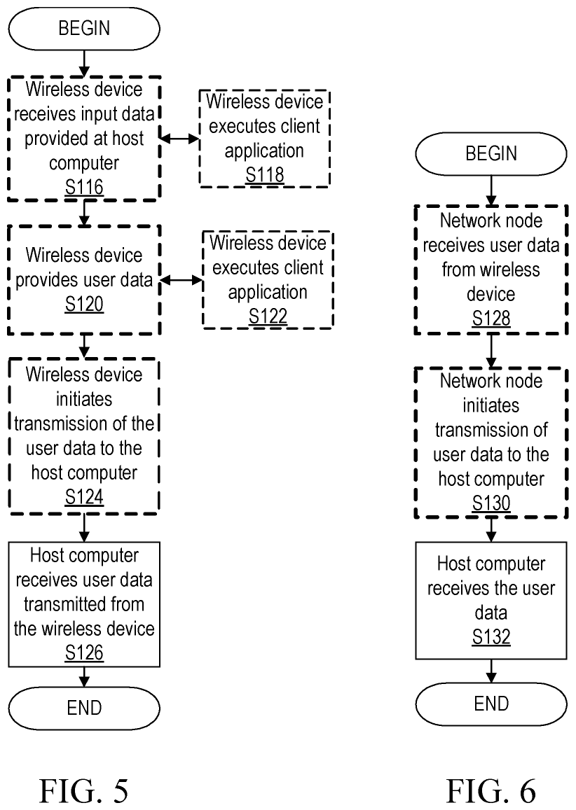

FIG. 5 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 6 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

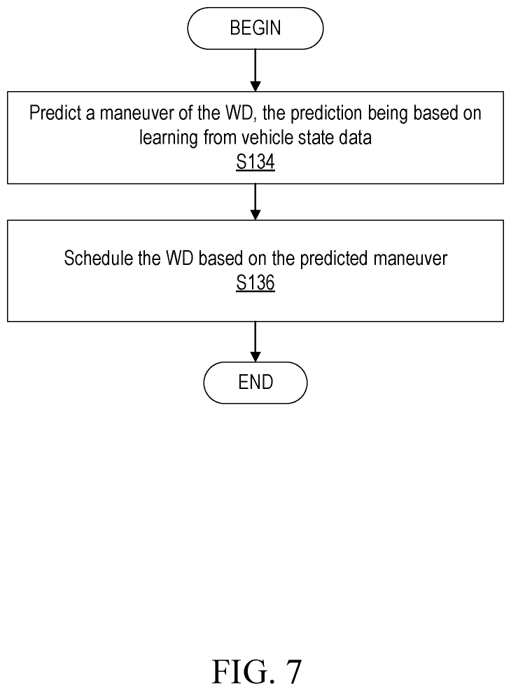

FIG. 7 is a flowchart of an example process in a network node 16 according to some embodiments of the present disclosure. One or more Blocks and/or functions and/or methods performed by the network node 16 may be performed by one or more elements of network node 16 such as by predictor unit 32 in processing circuitry 68, processor 70, radio interface 62, etc. according to the example method. The example method includes predicting (Block S134), such as via predictor unit 32, processing circuitry 68, processor 70 and/or radio interface 62, a maneuver of the WD, the prediction being based on learning from vehicle state data. The method includes scheduling (Block S136), such as via predictor unit 32, processing circuitry 68, processor 70 and/or radio interface 62, the WD based on the predicted maneuver.

In some embodiments, at least one of: the WD is a vehicular WD; the scheduling of the WD is an uplink grant; and the predicted maneuver comprises at least one of: changing lanes, passing another vehicle, crossing an intersection, coordinating a physical maneuver with at least one other neighboring vehicle and an intended/impending physical maneuver.

In some embodiments, the vehicle state data comprises at least one of: historical vehicle coordinate and speed data, a length of time associated with the historical data, a number of surrounding vehicles and data about surrounding vehicles at a time, t.

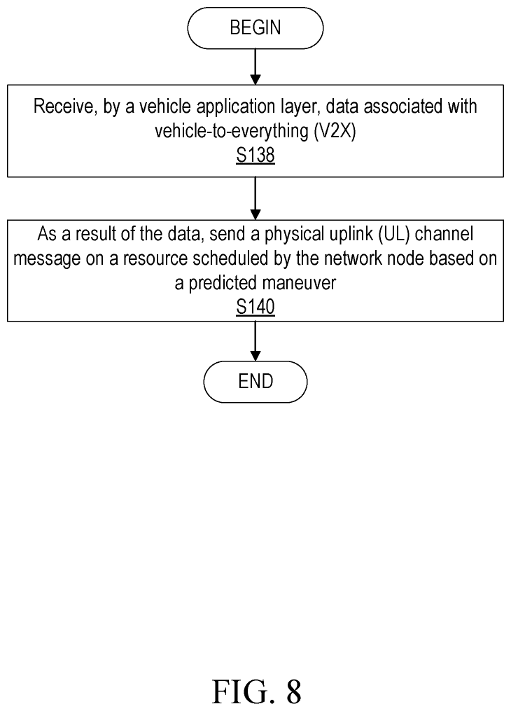

FIG. 8 is a flowchart of an example process in a wireless device 22 according to some embodiments of the present disclosure. One or more Blocks and/or functions and/or methods performed by WD 22 may be performed by one or more elements of WD 22 such as by maneuver unit 34 in processing circuitry 84, processor 86, radio interface 82, etc. The example method includes receiving (Block S138), such as via maneuver unit 34, processing circuitry 84, processor 86 and/or radio interface 82, by a vehicle application layer, data associated with vehicle-to-everything (V2X). The method includes as a result of the data, sending (Block S140), such as via maneuver unit 34, processing circuitry 84, processor 86 and/or radio interface 82, a physical uplink (UL) channel message on a resource scheduled by the network node based on a predicted maneuver.

In some embodiments, at least one of: the WD is a vehicular WD; the scheduling of the WD is an uplink grant; and the predicted maneuver comprises at least one of: changing lanes, passing another vehicle, crossing an intersection, coordinating a physical maneuver with at least one other neighboring vehicle and an intended/impending physical maneuver.

In some embodiments, the vehicle state data comprises at least one of: historical vehicle coordinate and speed data, a length of time associated with the historical data, a number of surrounding vehicles and data about surrounding vehicles at a time, t.

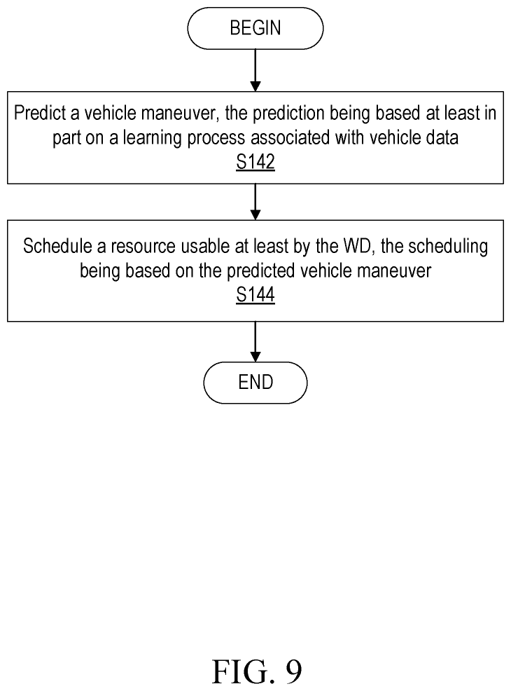

FIG. 9 is a flowchart of an example process in a network node 16 according to some embodiments of the present disclosure. One or more Blocks and/or functions and/or methods performed by the network node 16 may be performed by one or more elements of network node 16 such as by predictor unit 32 in processing circuitry 68, processor 70, radio interface 62, etc. according to the example method. The example method includes predict (Block S142) a vehicle maneuver, where the prediction is based at least in part on a learning process associated with vehicle data; and schedule (Block S144) a resource usable at least by the WD 22. The scheduling is based on the predicted vehicle maneuver In some embodiments, the method further includes at least one of receiving the vehicle data from the WD 22; transmitting first signaling to the WD 22 including the scheduled resource; receiving second signaling from the WD 22 based on the scheduled resource; and transmitting third signaling to another WD 22 based on the scheduled resource. The third signaling is usable by the other WD 22 to determine that the vehicle maneuver has been predicted.

In some other embodiments, the scheduled resource is usable at least by the WD to at least one of perform at least one action associated with vehicle to everything (V2X) communication; and trigger a cooperative driving action.

In an embodiment, the method further includes determining a probability of the vehicle maneuver to predict the vehicle maneuver.

In another embodiment, the method further includes one of activating and deactivating a semi-static scheduling of the resource based on the determined probability and a probability threshold.

In some embodiments, the probability is determined based at least on an input associated with the learning process.

In some other embodiments, the resource is scheduled to be transmitted in advance of the vehicle maneuver occurring by at least a predetermined interval of time.

In an embodiment, the method further includes performing the learning process based at least in part on the vehicle data.

In another embodiment, at least one of the WD 22 is a vehicular WD 22; the scheduled resource is at least one of an uplink grant and a downlink grant; and the predicted vehicle maneuver comprises at least one of changing lanes; passing another vehicle; crossing an intersection; coordinating a physical maneuver with at least one neighboring vehicle; and a maneuver expected to be performed by the vehicle within a predetermined interval of time.

In some embodiments, the vehicle data comprises at least one of historical data; vehicle coordinate and speed data; an interval of time associated with the historical data; a quantity of surrounding vehicles; and data about the surrounding vehicles at a predetermined time.

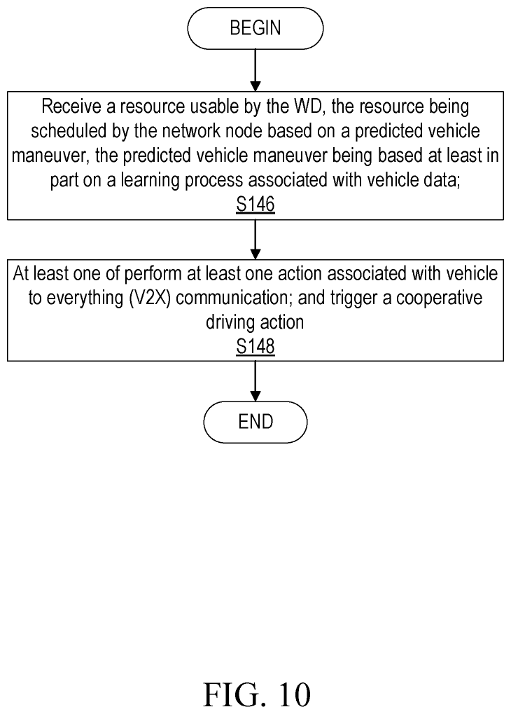

FIG. 10 is a flowchart of an example process in a wireless device 22 according to some embodiments of the present disclosure. One or more Blocks and/or functions and/or methods performed by WD 22 may be performed by one or more elements of WD 22 such as by maneuver unit 34 in processing circuitry 84, processor 86, radio interface 82, etc. The example method includes receive (Block S146) a resource usable by the WD 22, where the resource is scheduled by the network node 16 based on a predicted vehicle maneuver, and the predicted vehicle maneuver is based at least in part on a learning process associated with vehicle data; and at least one of (Block S148) perform at least one action associated with vehicle to everything (V2X) communication; and trigger a cooperative driving action.

In some embodiments, the method further includes at least one of transmitting the vehicle data to the network node 16; receiving first signaling from the network node 16 including the received resource; transmitting second signaling to the network node 16 based on the received resource; and transmitting third signaling to another WD 22 based on the received resource. The third signaling is usable by the other WD 22 to determine that the vehicle maneuver has been predicted.

In an embodiment, the predicted vehicle maneuver is based on a probability.

In another embodiment, a semi-static scheduling of the resource is one of activated and deactivated based on the probability and a probability threshold.

In some embodiments, the probability is based at least on an input associated with the learning process.

In some other embodiments, the resource is scheduled to be transmitted in advance of the vehicle maneuver occurring by at least a predetermined interval of time.

In an embodiment, the learning process is based at least in part on the vehicle data.

In another embodiment, at least one of the WD 22 is a vehicular WD 22; and the received resource is at least one of an uplink grant and a downlink grant.

In some embodiments, the predicted vehicle maneuver comprises at least one of changing lanes; passing another vehicle; crossing an intersection; coordinating a physical maneuver with at least one neighboring vehicle; and a maneuver expected to be performed by the vehicle within a predetermined interval of time.

In some other embodiments, the vehicle data comprises at least one of historical data; vehicle coordinate and speed data; an interval of time associated with the historical data; a quantity of surrounding vehicles; and data about the surrounding vehicles at a predetermined time.

Having described the general process flow of arrangements of the disclosure and having provided examples of hardware and software arrangements for implementing the processes and functions of the disclosure, the sections below provide details and examples of arrangements for resource allocation/scheduling (e.g., enhanced C-V2X uplink resource allocation/scheduling) using vehicle maneuver prediction, which may be implemented by the network node 16, wireless device 22 and/or host computer 24.

### Introduction and System Overview

Service requirements for enhanced C-V2X scenarios are defined in terms of payload, latency and reliability of the communication link, e.g., as in the 3GPP standards. For instance, at a lower degree of driving automation, the network node supports a success rate over 90% in packet delivery with maximum allowed latency 25 ms for 300-400 byte of payload. This level of automation typically includes only the intention of maneuvering; however, to reach a higher level of automation, a vehicle WD 22 is expected to transmit further information, e.g., estimated future trajectory and sensory data. To fully support cooperative driving at the maximum level of automation, service requirements increase up to 10 ms, 12 KB and 99% reliability for latency, payload, and reliability respectively.

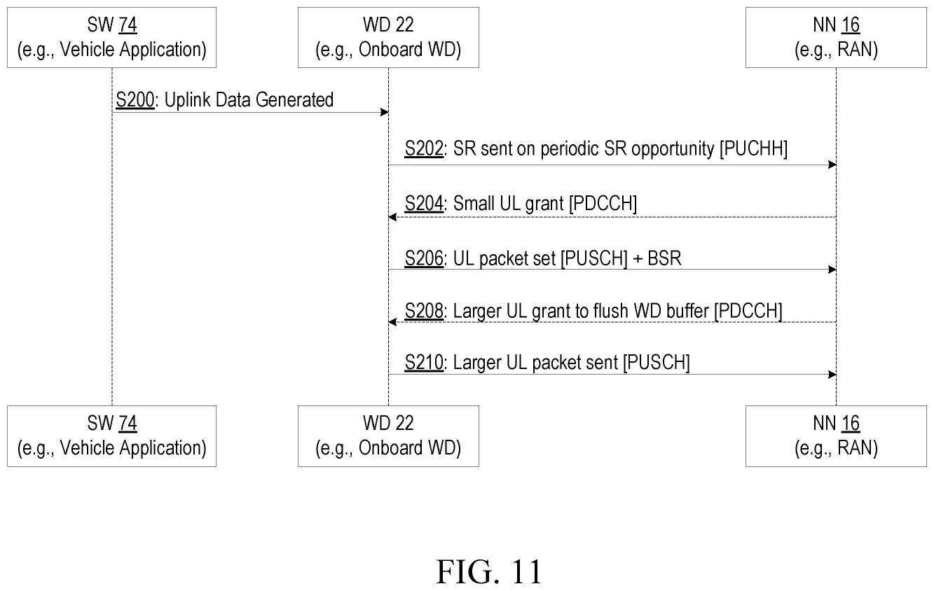

Typical 5G network capabilities are not able to support such strict requirements. One bottleneck present in the current 5G technology is uplink resource scheduling. Traditionally, dynamic grant scheme is used for uplink resource granting in C-V2X, as shown in FIG. 11 for example. At step, S200, uplink data may be generated by software 74 (e.g., the vehicle application). At step S202, the WD 22 (e.g., an Onboard WD 22) then may send an SR on a periodic SR opportunity (PUCCH). At step S204, network node (NN) 16 may send a small UL grant via PDCCH. At step S206, WD 22 (e.g., an Onboard WD 22) may send an UL packet (on the granted PUSCH) that includes a BSR to NN 16. At step S208, NN 16 may send a larger UL grant to flush UE buffer via PDCCH (as per the BSR). At step S210, the WD 22 (e.g., an Onboard WD 22) may send the larger UL packet via the larger granted PUSCH. Such dynamic scheme relies on a round trip of control message exchange to establish the physical control channels (PUCCH-PDCCH). The latency resulting from this process alone can easily exceed the maximum acceptable delay to support cooperative driving in autonomous vehicles.

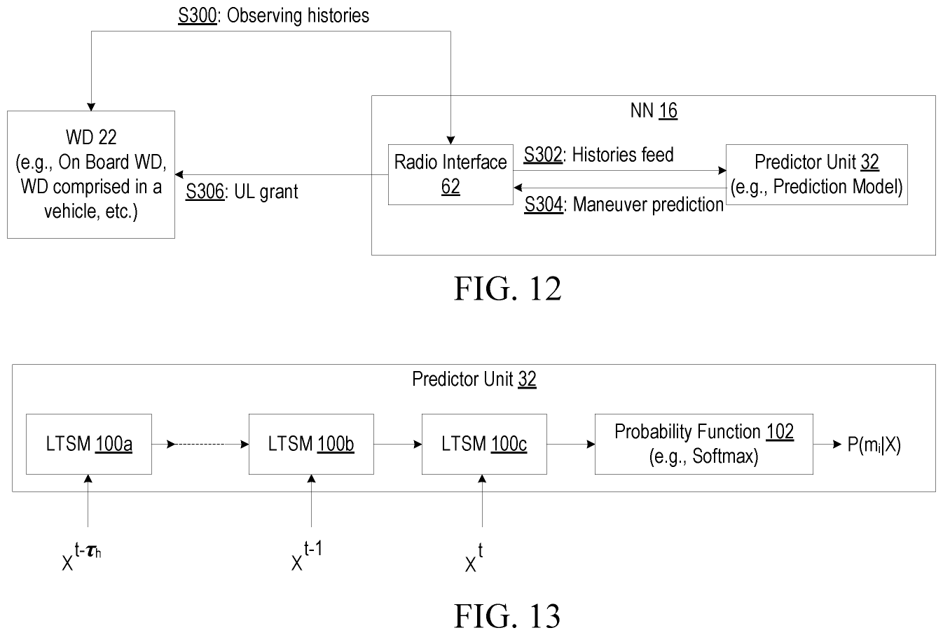

Some embodiments propose a new scheme for UL scheduling. An example system is shown in FIG. 12 and may include two (or more) components: (1) WD 22 (e.g., autonomous vehicle WD 22, an autonomous vehicle with an installed onboard WD 22), and (2) a network node 16 (e.g., gNB, including a radio interface 62) including predictor unit 32 (e.g., an installed prediction model). The WD 22 may transmit (e.g., constantly, periodically, every predetermined interval of time) data such as vehicle data, current state (e.g., x-y coordinates and speed). The data may include historical data (e.g., observed histories). The network node 16 may be configured to preserve data such as state histories of different connected vehicles for a window of time (Step S300). The data such as histories may be fed into predictor unit 32 (e.g., a prediction model) (Step 302). Using the data such as observed histories of autonomous vehicle (AV) states, the network node 16 may be configured to perform one or more predictions (Step 304), e.g., predict a maneuver associated with the vehicle and/or WD 22, predict the intention of future vehicle maneuvering through its prediction model, etc. That is, the network node 16 can estimate a future need for resources such as UL resources. Further, the network node 16 can proactively schedule resources (e.g., UL grants) to the WD 22 (Step 306), which may save the round trip delay present in the dynamic scheduling scheme (e.g., as shown in FIG. 11). The feasibility of the proposed scheme could be demonstrated through a simulated environment, as described in more detail below. In the following subsections, suggested implementation details on the simulation environment and the prediction model are described.

### Prediction Model

Any type of classifier may be used for maneuver prediction in the proposed system. Random Forest, Supported Vector Machines, Multilayer Perceptron and Recurrent Neural Networks are some examples. Some embodiments of the present disclosure describe the following guidelines usable for building the model.

In some embodiments, the model may be installed on the network node 16 side and its input is the vehicle data (e.g., track histories of vehicle) associated with WD 22 and/or the vehicle trajectories. The model input could be mathematically described as follows for example:

X=[x^{t-τ}, . . . ,x^{t-1},x^{t}]

x^{t}=[s₀^{t}, . . . ,sₙ₋₁^{t},sₙ^{t}].

Where τ is the length of track histories, n is the number of considered surrounding vehicles, s is the state of the surrounding vehicles at time t.

The vehicle data (e.g., states) may be transmitted periodically by the vehicle WDs 22 such as to be saved in network node 16 logs and/or memory 72. In general, a state of a vehicle (and/or vehicle WD 22) may be defined as its x, y coordinates and speed; however, handcrafted features could be added if it can be deduced on the network node 16 side, e.g., acceleration and angle of the vehicle (and/or WD 22) with respect to the road/thoroughfare.

The number/count of vehicles and/or corresponding WDs 22 within a predetermined distance (i.e., neighbor WDs 22) may be fixed and the input may be padded in case of insufficient number of neighbor WDs 22 around a target vehicle WD 22. In one or more nonlimiting empirical evaluations described herein, a performance that meets a predetermined threshold is achieved when using five neighbor WDs 22. Both adjacent on the target lane, and leading vehicle WDs 22 have shown to have an effect on the performance greater than a predetermined threshold. In some examples, excluding two neighbors from the input decreases the prediction accuracy by 8-17% depending on the classifier used in the experiment.

The output of the model may be formulated as one-dimensional vector Y representing the probabilities of different maneuvers and the suggested loss function is cross-entropy defined as, for example:

$$loss = - \sum p ( X ) log p ( X )$$

The choice of the prediction model may be made based on empirical study. A comparison between different types of classifiers under different prediction horizons is shown in Table 1 below.

TABLE 1
Accuracy by model.

| | 1 s | 2 s | 3 s | 4 s | 5 s |
|---|---|---|---|---|---|
| SVM | 82.1 | 79.8 | 77.4 | 74.1 | 70.7 |
| MLP | 74.3 | 70.9 | 66.5 | 62.2 | 58 |
| Random | 84.3 | 81 | 78.3 | 75.0 | 71.6 |
| Forest | | | | | |
| LSTM | 89.7 | 88.3 | 87.1 | 84.6 | 82.0 |

In some embodiments, Long Short Term Memory (LSTM) may provide the highest accuracy and lowest percentage of false positive predictions. FIG. 13 is a schematic diagram illustrating an example of a prediction model using one or more LSTMs 100 (e.g., LTSM 100a, LTSM 100b, LTSM 100c). A probability function (e.g., SoftMax) may further be used to receive information from LTSMs 100 and output a probability value, P(mᵢ|X) based on the received information. In one example, one or more values of P may be determined, e.g., where P=1 corresponds to a maximum value of a group of values included in the received information, and P=0 corresponds to a minimum value of the group of values.

It may be considered that the performance of other predictors is rooted in their inability to make use of history information. The maneuver information may be encoded within the sequence of events, i.e., relative change in speed and angle compared to previous states. Recurrent neural networks (RNNs) in general, and LSTM in particular, are able to discover long-term relationships between consequent states resulting in an outstanding performance. Close examination reveals a strong correlation between speed and LSTM prediction. For example, if the speed difference between target and leading vehicle WDs 22 is large compared to the rest of the traffic, the model is encouraged to predict a future lane change. Similarly, if the speed difference between target and adjacent vehicle WDs 22 is small, the probability of predicting lane change decreases drastically. In some embodiments, this behavior may not carried out by the typical predictors.

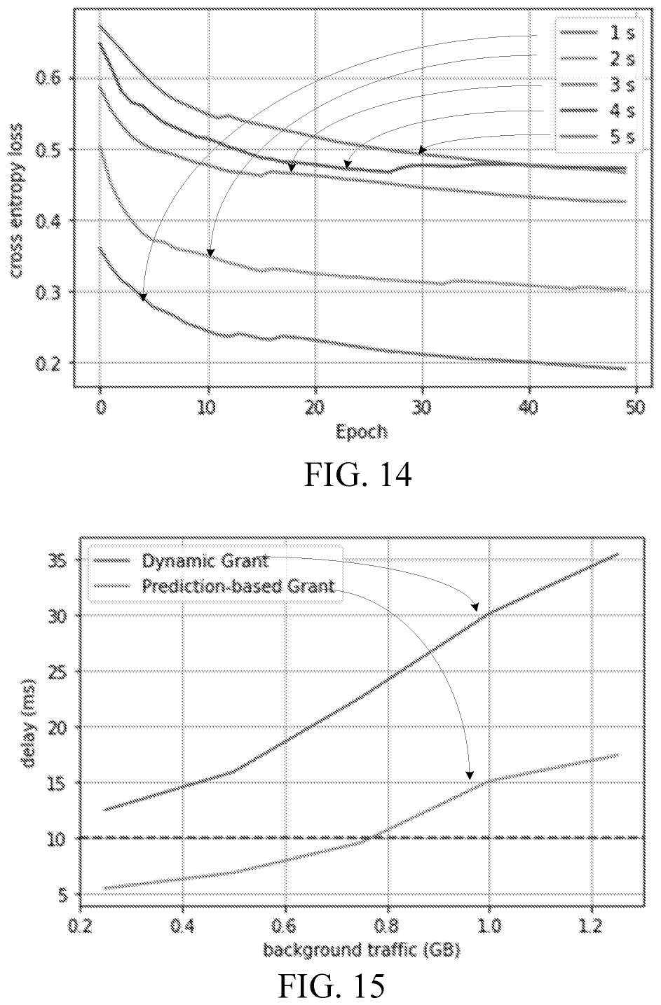

The example model was implemented using Keras (i.e., open-source software which provides an interface for artificial neural networks), where one or more LSTMs 100 (e.g., four LSTMs 100) were used (see FIG. 13) and the model was trained using Adam optimizer (i.e., optimization algorithm) with learning rate of 0.05. FIG. 14 shows an example of LSTM cross-entropy losses (e.g., for an example LSTM model under different prediction horizons).

### Waste of Resources and Latency Tradeoff

In some embodiments, the proposed solution may be arranged to stand in the middle between dynamic and configured grants. A tradeoff between waste of resources and aggregated saved latency may be performed (e.g., a result from introducing the maneuver prediction model). The miss-predictions of the model may be further classified into false positives and false negatives.

In cases of false positive prediction, i.e., the model incorrectly predicting a maneuver intention, unneeded resource grants may be scheduled for vehicles and/or WDs 22 that do not intend to perform a maneuver (i.e., for which a maneuver is predicted to not occur within a predetermined interval of time). In cases of false negative predictions, i.e., the model incorrectly predicting there is no intention to perform a maneuver, some vehicle WDs 22 may be configured to perform traditional dynamic scheme for UL scheduling.

The performance of the maneuver prediction model should not be assessed merely based on its classification accuracy. In some embodiments, it is suggested to perform an analysis on model recall and model precision. The precision of the model can be defined as, for example:

$$precision = \frac{True Positive}{True Positive + False Positives}$$

The recall of the model can be defined as, for example:

$$recall = \frac{True Positives}{True Positives + False Positives}$$

The precision and recall of the model could be controlled by manipulating the probability threshold the model uses to perform its final classification, e.g., assuming the model predicts a maneuver if the probability of maneuvering exceeds a threshold, then increasing this threshold may be expected to increase the model precision on the expense of its recall and vice versa. The threshold can set by the operator to achieve the desired precision-recall tradeoff which translates into latency-resource tradeoff.

### Example Simulation of the Proposed Solution

To test the feasibility of some aspects of the proposed solution, it is suggested to build a simulation environment using e.g., 5G-LENA software. 5G-LENA is a GPLv2 New Radio (NR) network simulator, designed as a pluggable module to NS-3 network simulator. In this environment, network nodes 16 could be modeled as fixed in place nodes distributed over the simulation area. The distribution of network nodes 16 may preserve roughly 500 meters as maximum distance between nodes to allow optimum 5G coverage. The load on the network could be simulated through background traffic resulting from fixed nodes periodically exchanging empty packets with the network nodes 16 on both downlink and uplink.

The vehicle WDs 22 could be modeled in NS-3 (i.e., network simulator) as mobile nodes (i.e., WDs) with their location updated using a mobility dataset. NS-3 updates node coordinates with 10 ms periodicity. The mobility dataset contains trajectories of vehicle traffic with 100 Hz frequency. The dataset could be handcrafted using, for example, a Simulation of Urban MObility (SUMO) simulator or constructed by drawing vehicle trajectories from the publicly available next generation simulation (NGSIM) datasets. More specifically, SUMO is an open source, highly portable, microscopic and continuous multi-modal simulator designed to handle large traffic. Next Generation Simulation (NGSIM) datasets are part of the Intelligent Transportation Systems (ITS) program and may include trajectories of real freeway traffic captured at segments of mild, moderate and congested traffic conditions.

Moreover, vehicular WDs 22 may have installed netDevice (e.g., a physical interface on a device/node), user datagram protocol (UDP) server (udp-server), and a udp-client on the application layer. In NS-3, the udp-server class can be used to collect statistics on latency and delivery success rate of packet exchange.

In some embodiments, the UDP clients (e.g., running on the vehicular WDs 22) may be configured to perform two tasks.

First, the udp client transmits e.g., 20 bytes of payload. This payload may be divided into 12 bytes for vehicle state, defined as e.g., x,y coordinates and vehicle speed, and 8 bytes for UDP header. The suggested periodicity of state transmission may be e.g., 100 ms as this may be considered the minimum acceptable periodicity to preserve an acceptable accuracy by the prediction model. Transmitting state information may not be considered as an overhead since it is useful for other V2X applications.

Second, the UDP client may transmit scheduled maneuver information. The estimated payload for maneuver information may be decided by the service provider. The payload of maneuver message may depend on the required degree of automation; hence, service provider may be expected to have the ability to switch between supported automation levels based on network parameters and its own regulations. A guideline on the information included in maneuver messages and their corresponding estimated payloads under different automation degrees may be provided by the 3GPP standard.

The suggested scenario to study the performance of both dynamic and proposed schemes works as follows. Some aspects may include extracting the maneuver times and mobile node (e.g., vehicular WD 22) coordinates from the mobility dataset. These may be saved in proper format to be read later by NS-3. Further, NS-3 events that perform maneuver packet exchange between a mobile node and its surroundings within a predetermined radius of communication at the specified times may be scheduled. Third, WD coordinates (e.g., mobile nodes coordinates) may be updated. Fourth, the maneuver packet delays resulting from this experiment using the NS-3 UDP-server class may be collected. The resulting delays may then be used to assess the performance of the dynamic uplink granting scheme.

To assess the performance of some aspects of the proposed solution, statistics may be collected on the latency resulting from uplink grant scheduling then shift the scheduling times of maneuver packet exchange back in time based on the collected statistics and maneuver prediction. The goal may be considered to compensate for the latency resulting from the scheduling process whenever the maneuver is predicted correctly in advance. The required statistics could be collected in NS-3 by logging transmission times of control messages (SR, PUCCH, and PDCCH) on the medium access control (MAC) layer of the netDevice installed on mobile nodes. Specifically, the following steps may be executed to assess the performance of the proposed scheme:
1. Conduct the aforementioned experiment using a dynamic UL scheduling scheme.
2. For each vehicle WD 22: log the times of receiving large UL grants over PDCCH.
3. Outside NS-3: run the predictor on vehicle WD 22 trajectories.
   a. For the true positive predictions, i.e., vehicle WDs 22 correctly predicted as intending to perform maneuver, shift the scheduled transmission from t to t-τ where t is the transmission time scheduled in step 1 and τ is the estimated delay exhausted in the dynamic scheme for UL resource allocation.
   b. For false negative predictions, i.e., vehicle WDs 22 predicted as not intending to perform maneuver while it intends to perform a maneuver: schedule the transmission time as t where t is the transmission time as in step 1 left intact.
   c. For false positive predictions, i.e., vehicle WDs 22 predicted as intending to perform a maneuver while it does not intend to perform a maneuver: add new transmissions to the NS-3 scheduled maneuver files at time t=t_v where t_v is the time of the last saved coordinate for the vehicle WD 22 extracted from the mobility dataset.
4. Repeat the process with the modified scheduling times.

Further, to test the feasibility of some aspects of the proposed solution, a simulation environment may be built following the aforementioned guidelines with the following specifications: the mobility dataset was constructed using NGSIM. In the example, only one network node 16 was used to forward the maneuver messages between moving vehicle WDs 22. This network node 16 was centered between the moving vehicle WDs 22 and it had 64 isotropic antennas with a height of 35 meters for each antenna. Furthermore, only one single band that is composed of one single carrier was used. The central frequency of the carrier was 3.5 GB and the bandwidth was 20 MHz. A NS-3 RMa scenario was used as a propagation loss model to simulate signal propagation in a highway environment. For background traffic, the interval between each packet was also drawn from a uniform distribution with the maximum delay of 10 microseconds. The size of each packet was 500 bytes. The number of fixed nodes is a variable to control the load on the network node 16 during the experiment. Finally, to test the feasibility of the proposed solution, a simulation environment may be built following the aforementioned guidelines with the following specifications: the mobility dataset was constructed using NGSIM.

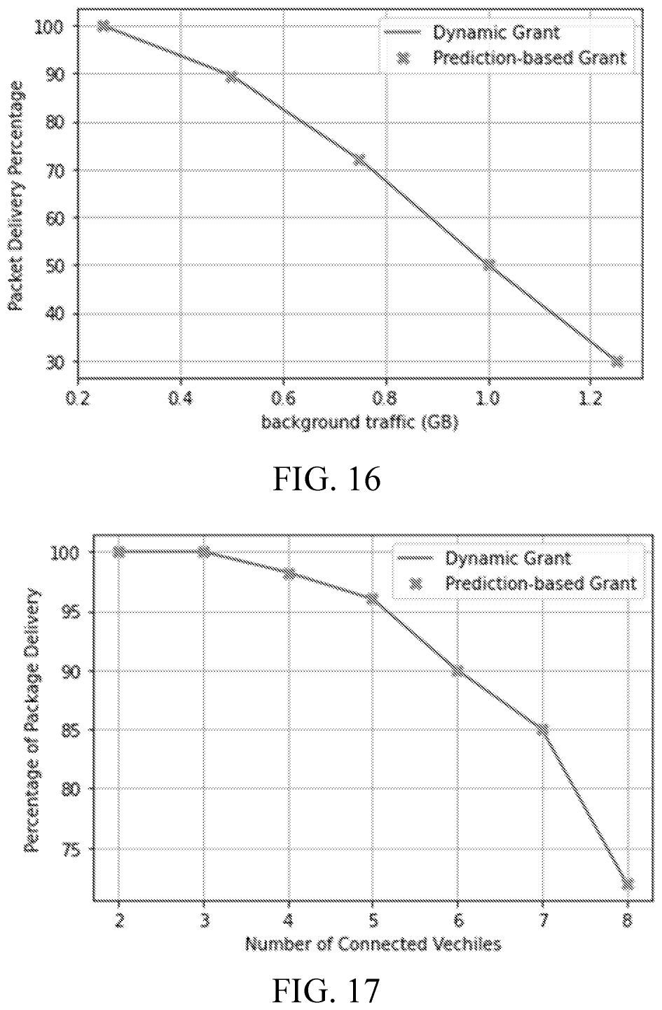

FIGS. 15 and 16 show examples of the performance in terms of packet delay for both schemes subjected to varying network loads. The payload for each maneuver event was set to 12 KB to test the performance under the constraint of the highest level of driving automation. Both schemes score almost identical packet delivery rate, and both tend to suffer in terms of reliability when the network is subjected to increased volumes of background traffic. Moreover, the simulations have shown that packet delivery rate is also drastically affected by the number of connected vehicles.

FIG. 17 shows an example of the packet delivery rate against an increased number of neighboring vehicle WDs 22 addressed by the maneuver intention notification. It is of note that, this experiment was simulated using a single gNB; hence, the degradation of performance, degradation resulting from the overloaded network node 16 (base station), is expected.

Finally, both average delay and waste of resources in the proposed scheme could be controlled by manipulating prediction thresholds α where α is defined as the minimum probability required by the model to predict maneuver intention. Increasing the prediction threshold α results in being more conservative in predicting maneuvers; hence, less waste of resources on the expense of average delay. This is similar to semi-static methods (such as configured grant) in which the tradeoff can be controlled by manipulating the periodicity of granting resources.

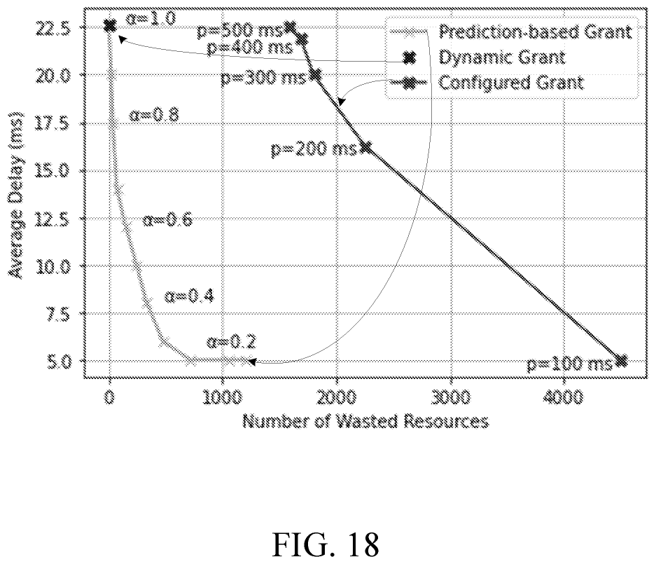

FIG. 18 shows an example of the tradeoff between waste of resources, defined as the number of times unneeded resources are granted, and average delay under different periodicities (in milliseconds) for configured grant scheme (an example of a semi-static scheme) and different values of α for the proposed method. For the configured grant, it may be assumed that the periodic grant is large enough to carry 12 KB for simplicity. The results show that the dynamic scheme performs best in terms of waste of resources, as it doesn't suffer from waste, but it exhibits higher delay when compared to other schemes. On the other hand, both configured grant and the proposed schemes exhibit better performance in terms of delay with the proposed scheme performing considerably better in terms of resource waste. The huge waste resulting in the configured grant scheme is a direct result of blindly granting resources with each periodicity. Granting resources is better handled in the proposed scheme by relying on maneuver prediction.

Enhancing Semi-Static Schemes with the Proposed Scheme

As mentioned above, semi-static UL scheduling schemes that semi-statically allocate UL resources in advance, such as UL configured grants or semi-persistent scheduling, improve latency but they suffer from wasted UL resources. In some embodiments, the proposed scheme that predicts vehicle WD 22 maneuver can be combined with such semi-static schemes to reduce the resource waste as follows, for example:
Activate semi-static UL scheduling if the predicted probability of maneuver is greater than or equal to a threshold; and
Deactivate semi-static UL scheduling if the predicted probability of maneuver less than the threshold.

The examples described with respect to FIGS. 14-18 are used to illustrate example cross entropy loss, reliability, and/or average delay, etc. However, the embodiments of the present disclosure are not limited as such and may be tested and/or assessed and/or performed in any other way.

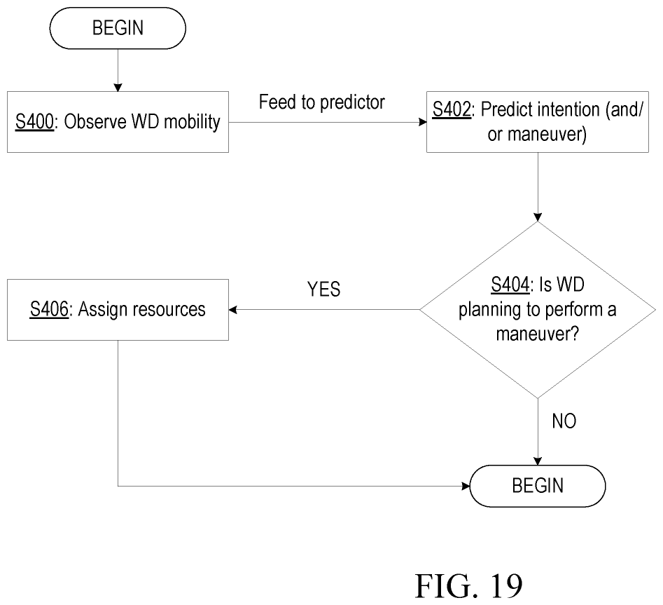

FIG. 19 illustrates an example UL scheduling according to some embodiments of the present disclosure. At step S400, vehicle WD 22 mobility may be observed (e.g., by vehicle WD 22 and/or NN 16). At step S402, such observations may be fed to a predictor unit 32 (e.g., a prediction model, a predictor, etc.), which may predict the vehicle maneuver (e.g., vehicle maneuver intention, maneuver of the vehicle associated with WD 22). At step S404, it may be determined whether the WD 22 and/or vehicle is planning to (and/or expected to) perform a maneuver (e.g., change lanes). If the WD 22 and/or vehicle is not planning to perform (and/or expected to) the maneuver, the process may end or restart from the beginning or any other step. At step S406, if the WD 22 and/or vehicle is planning to perform (and/or expected to) the maneuver, NN 16 assigns resources (e.g., grants UL resources to the vehicle WD 22, schedules/allocates resources to the WD 22).

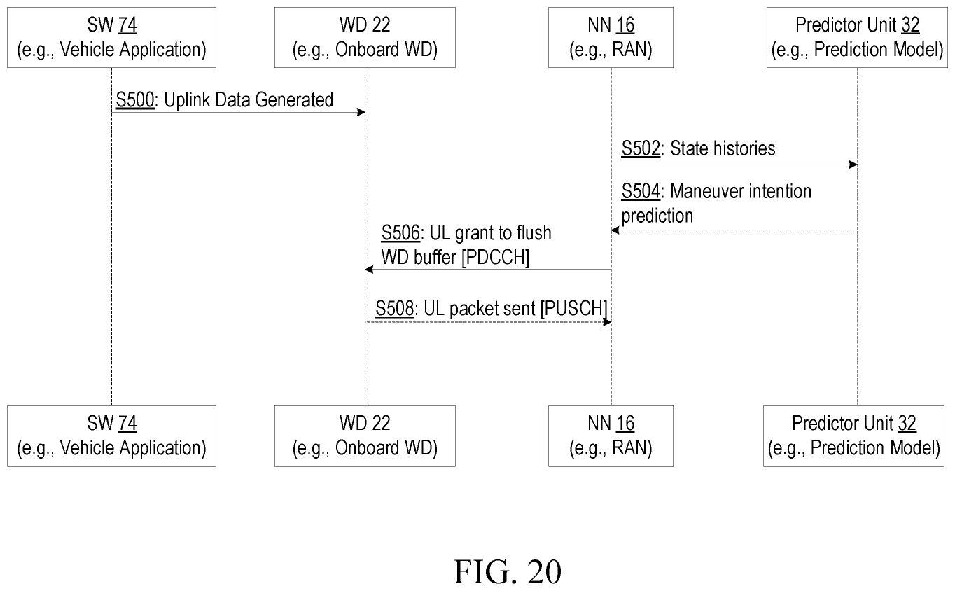

FIG. 20 illustrates an example of another UL scheduling arrangement according to some embodiments of the present disclosure. This arrangement may be distinguished from the existing UL scheduling arrangement, such as for example shown in FIG. 11. At step S500, the process may begin with uplink data being generated by the software 74 (e.g., vehicle software application) such as the vehicle corresponding to WD 22, which is indicated to the WD 22 (e.g., Onboard WD 22). At step S502, over on the network side, NN 16 provides vehicle WD 22 state histories (i.e., vehicle data) to predictor unit 32 (e.g., the prediction model). Although predictor unit 32 is described as part of NN 16, predictor unit 32 may be standalone or running on another device connected to NN 16. At step S504, the predictor unit 32 (e.g., prediction model) may then provide/perform a prediction such as a maneuver intention prediction for vehicle WD 22. At step S506, NN 16 may send an UL grant to vehicle WD 22 via PDCCH (e.g., to flush a WD buffer). At step S508, WD 22 then sends an UL packet via the granted PUSCH. The UL packet may include the uplink data generated in the beginning of the process. As is apparent from a comparison of FIGS. 11 and 20, at the very least, the proposed solution avoids the resource waste and delay associated with the SR request, small UL grant and UL packet sent with the BSR that is associated with existing UL scheduling arrangements.

Using one or more of the aforementioned methods and arrangements, the wasted resources and/or delay (e.g., from existing UL scheduling arrangements) may be significantly reduced.

The following is a nonlimiting list of example embodiments:

Embodiment A1. A network node configured to communicate with a wireless device (WD), the network node configured to, and/or comprising a radio interface and/or comprising processing circuitry configured to:
predict a maneuver of the WD, the prediction being based on learning from vehicle state data; and
schedule the WD based on the predicted maneuver.

Embodiment A2. The network node of Embodiment A1, wherein at least one of:
the WD is a vehicular WD;
the scheduling of the WD is an uplink grant; and
the predicted maneuver comprises at least one of: changing lanes, passing another vehicle, crossing an intersection, coordinating a physical maneuver with at least one other neighboring vehicle and an intended/impending physical maneuver.

Embodiment A3. The network node of Embodiment A1, wherein the vehicle state data comprises at least one of: historical vehicle coordinate and speed data, a length of time associated with the historical data, a number of surrounding vehicles and data about surrounding vehicles at a time, t.

Embodiment B1. A method implemented in a network node, the method comprising:
predicting a maneuver of the WD, the prediction being based on learning from vehicle state data; and
scheduling the WD based on the predicted maneuver.

Embodiment B2. The method of Embodiment B1, wherein at least one of:
the WD is a vehicular WD;
the scheduling of the WD is an uplink grant; and
the predicted maneuver comprises at least one of: changing lanes, passing another vehicle, crossing an intersection, coordinating a physical maneuver with at least one other neighboring vehicle and an intended/impending physical maneuver.

Embodiment B3. The method of Embodiment B1, wherein the vehicle state data comprises at least one of: historical vehicle coordinate and speed data, a length of time associated with the historical data, a number of surrounding vehicles and data about surrounding vehicles at a time, t.

Embodiment C1. A wireless device (WD) configured to communicate with a network node, the WD configured to, and/or comprising a radio interface and/or processing circuitry configured to:
receive, by a vehicle application layer, data associated with vehicle-to-everything (V2X); and
as a result of the data, send a physical uplink (UL) channel message on a resource scheduled by the network node based on a predicted maneuver.

Embodiment C2. The WD of Embodiment C1, wherein at least one of:
the WD is a vehicular WD;
the scheduling of the WD is an uplink grant; and
the predicted maneuver comprises at least one of: changing lanes, passing another vehicle, crossing an intersection, coordinating a physical maneuver with at least one other neighboring vehicle and an intended/impending physical maneuver.

Embodiment C3. The WD of Embodiment C1, wherein the vehicle state data comprises at least one of: historical vehicle coordinate and speed data, a length of time associated with the historical data, a number of surrounding vehicles and data about surrounding vehicles at a time, t.

Embodiment D1. A method implemented in a wireless device (WD), the method comprising:
receiving, by a vehicle application layer, data associated with vehicle-to-everything (V2X); and
as a result of the data, sending a physical uplink (UL) channel message on a resource scheduled by the network node based on a predicted maneuver.

Embodiment D2. The method of Embodiment D1, wherein at least one of:
the WD is a vehicular WD;
the scheduling of the WD is an uplink grant; and
the predicted maneuver comprises at least one of: changing lanes, passing another vehicle, crossing an intersection, coordinating a physical maneuver with at least one other neighboring vehicle and an intended/impending physical maneuver.

Embodiment D3. The method of Embodiment D1, wherein the vehicle state data comprises at least one of: historical vehicle coordinate and speed data, a length of time associated with the historical data, a number of surrounding vehicles and data about surrounding vehicles at a time, t.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:

| Abbreviation | Explanation |
|---|---|
| UE | User equipment (UE) is any device used |
| | directly by an end-user to communicate. |
| gNB | Next Generation NodeB (gNB) is the term used to |
| | describe base stations in fifth generation networks. |

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A network node configured to communicate with a wireless device, WD, the WD corresponding to a vehicle, the network node comprising processing circuitry configured to:
predict a vehicle maneuver, the prediction being based at least in part on a learning process associated with vehicle data; and
schedule a resource usable at least by the WD, the scheduling being based on the predicted vehicle maneuver.

2. The network node of claim 1, wherein the network node further comprises a radio interface in communication with the processing circuitry, the radio interface configured to at least one of:
receive the vehicle data from the WD;
transmit first signaling to the WD including the scheduled resource;
receive second signaling from the WD based on the scheduled resource; and
transmit third signaling to another WD based on the scheduled resource, the third signaling being usable by the other WD to determine that the vehicle maneuver has been predicted.

3. The network node of claim 1, wherein the scheduled resource is usable at least by the WD to at least one of:
perform at least one action associated with vehicle to everything, V2X, communication; and
trigger a cooperative driving action.

4. The network node of claim 1, wherein the processing circuitry is further configured to:
determine a probability of the vehicle maneuver to predict the vehicle maneuver.

5. The network node of claim 4, wherein the processing circuitry is further configured to:
one of activate and deactivate a semi-static scheduling of the resource based on the determined probability and a probability threshold.

6. The network node of claim 4, wherein the probability is determined based at least on an input associated with the learning process.

7. The network node of claim 1, wherein the resource is scheduled to be transmitted in advance of the vehicle maneuver occurring by at least a predetermined interval of time.

8. The network node of claim 1, wherein the processing circuitry is further configured to:
perform the learning process based at least in part on the vehicle data.

9. The network node of claim 1, wherein at least one of:
the WD is a vehicular WD;
the scheduled resource is at least one of an uplink grant and a downlink grant; and
the predicted vehicle maneuver comprises at least one of:
changing lanes;
passing another vehicle;
crossing an intersection;
coordinating a physical maneuver with at least one neighboring vehicle; and
a maneuver expected to be performed by the vehicle within a predetermined interval of time.

10. The network node of claim 1, wherein the vehicle data comprises at least one of:
historical data;
vehicle coordinate and speed data;
an interval of time associated with the historical data;
a quantity of surrounding vehicles; and
data about the surrounding vehicles at a predetermined time.

11. A method in a network node configured to communicate with a wireless device, WD, the WD corresponding to a vehicle, the method comprising:
predicting a vehicle maneuver, the prediction being based at least in part on a learning process associated with vehicle data; and
scheduling a resource usable at least by the WD, the scheduling being based on the predicted vehicle maneuver.

12. The method of claim 11, wherein the method further includes at least one of:
receiving the vehicle data from the WD;
transmitting first signaling to the WD including the scheduled resource;
receiving second signaling from the WD based on the scheduled resource; and
transmitting third signaling to another WD based on the scheduled resource, the third signaling being usable by the other WD to determine that the vehicle maneuver has been predicted.

13. The method of claim 11, wherein the scheduled resource is usable at least by the WD to at least one of:
perform at least one action associated with vehicle to everything, V2X, communication; and
trigger a cooperative driving action.

14. The method of claim 11, wherein the method further includes:
determining a probability of the vehicle maneuver to predict the vehicle maneuver.

15. The method of claim 14, wherein the method further includes:
one of activating and deactivating a semi-static scheduling of the resource based on the determined probability and a probability threshold.

16. The method of claim 14, wherein the probability is determined based at least on an input associated with the learning process.

17. The method of claim 11, wherein the resource is scheduled to be transmitted in advance of the vehicle maneuver occurring by at least a predetermined interval of time.

18. The method of claim 11, wherein the method further includes:
performing the learning process based at least in part on the vehicle data.

19. The method of claim 11, wherein at least one of:
the WD is a vehicular WD;
the scheduled resource is at least one of an uplink grant and a downlink grant; and
the predicted vehicle maneuver comprises at least one of:
changing lanes;
passing another vehicle;
crossing an intersection;
coordinating a physical maneuver with at least one neighboring vehicle; and
a maneuver expected to be performed by the vehicle within a predetermined interval of time.

20. The method of claim 11, wherein the vehicle data comprises at least one of:
historical data;
vehicle coordinate and speed data;
an interval of time associated with the historical data;
a quantity of surrounding vehicles; and
data about the surrounding vehicles at a predetermined time.

21.-40. (canceled)
